(19) United States
(12) Patent Application Publication
(10) Pub. No.: US 2024/0326010 A1
(43) Pub. Date: Oct. 3, 2024

(54) HIGH CAPACITY HYDROTHERMALLY STABLE ADSORBENT FOR REMOVAL OF CHLORIDES

(71) Applicant: UOP LLC, Des Plaines, IL (US)

(72) Inventors: Gautam Pandey, Haryana (IN); Jatin Kumar, Haryana (IN); Vishal Sharma, Haryana (IN); Ajit C. Garade, Haryana (IN); Arghya Maitra, Haryana (IN); Silpa S, Haryana (IN); Makrand Belsare, Haryana (IN)

(21) Appl. No.: 18/416,529

(22) Filed: Jan. 18, 2024

Related U.S. Application Data
(60) Provisional application No. 63/493,413, filed on Mar. 31, 2023.

(51) Int. Cl. B01J 20/18; B01D 53/04; B01J 20/02; B01J 20/04; B01J 20/28; B01J 20/30

(52) U.S. Cl. CPC B01J 20/18; B01D 53/04; B01J 20/0244; B01J 20/043; B01J 20/28011; B01J 20/2803; B01J 20/28059; B01J 20/28061; B01J 20/3007; B01J 20/3042; B01J 20/3078; B01D 2253/1085; B01D 2253/1124; B01D 2253/25; B01D 2253/306; B01D 2257/2045

(57) ABSTRACT

Adsorbent compositions are described. The adsorbent compositions include a metal oxide/mixed metal oxide component, a zeolite component, a metal carbonate component, and optionally a binder. The adsorbent compositions provide high inorganic and organic chloride capacity, controlled acidity, low polymerization/green oil formation, improved hydrothermal stability and mechanical properties including crush strength, increased adsorbent life, and fewer plugging byproduct-formation concerns. Methods of removing organic chlorides and inorganic chlorides from a process fluid using the adsorbent compositions are also described.

### RELATED APPLICATIONS

This application claims priority to U.S. Provisional Patent Application Ser. No. 63/493,413, filed on Mar. 31, 2023, the entirety of which is incorporated herein by reference.

### BACKGROUND

In catalytic reforming processes, chlorides are injected to maintain the activity (acid as well as hydrogenation function) of the catalyst. During operation, some chloride species leached out from the catalyst surface, and, as a result, the product streams often contain chloride species at low ppm levels. The presence of chlorides in product stream poses several problems, including the formation and deposition of ammonium chloride, corrosion, poisoning of downstream catalysts and product specification issues.

To overcome these problems, chloride removal adsorbents have been installed downstream to catalytic reforming unit. Various types of chloride adsorbents are offered commercially by different catalyst suppliers. These adsorbents are mainly classified into three types: (i) alkali activated alumina; (ii) metal oxide/mixed metal oxides; and (iii) zeolite based.

The existing adsorbents suffer from operational issues such as poor hydrothermal stability and mechanical properties, a short lifecycle, green oil formation, an increase in pressure drop, downstream corrosion, and catalyst deactivation. In addition, none of the existing adsorbents have high inorganic and organic chloride removal capacity.

Refinery and petrochemical operators have realized that there is a significant and growing need for improved capacity to remove both inorganic and organic chlorinated species from refinery streams.

Therefore, there is a need for improved adsorbents with the capacity to remove both inorganic and organic chlorinated species.

### BRIEF DESCRIPTION OF THE DRAWINGS

FIG. 1 is a graph comparing the inorganic chloride capacity of an adsorbent of the present invention with typical commercial chloride adsorbents.

FIG. 2 is a graph comparing the organic chloride capacity of an adsorbent of the present invention with typical commercial chloride adsorbents.

FIG. 3 is a graph comparing the crush strength of a fresh adsorbent, a spent adsorbent, and a steamed spent adsorbent of the present invention.

FIGS. 4A-C are photographs showing typical activated alumina after steaming, typical mixed metal oxide after HCl treatment, and the adsorbent of the present invention after HCl treatment.

FIG. 5 is a graph comparing the crush strength of fresh and steamed activated alumina with fresh and steamed adsorbent of the present invention.

### DESCRIPTION

The adsorbent composition utilizes a combination of a metal oxide/mixed metal oxide component for enhanced inorganic chloride uptake and a zeolite component to remove organic chlorides, which were previously untreatable by MMO and alumina absorbent. It also includes a metal carbonate component for inorganic chloride removal. The adsorbent composition provides high inorganic and organic chloride capacity, controlled acidity, low polymerization/green oil formation, improved hydrothermal stability and mechanical properties including crush strength, increased adsorbent life, and fewer plugging byproduct-formation concerns.

The adsorbent comprises a zeolite component consists essentially of an X type zeolite. There can be one or more X type zeolites. The zeolite component is present in an amount in a range of 30 to 70 wt % of the adsorbent composition, or 30 to 65 wt %, 30 to 60 wt %, 35 to 70 wt %, 35 to 65 wt %, or 35 to 60 wt %, or 40 to 70 wt %, or 40 to 65 wt %, or 40 to 60 wt %.

In some embodiments, the X type zeolite has a ratio of SiO₂/Al₂O₃ of 2.0 to 2.5, or a particle size in a range of 1.5 to 6 microns, or both. In some embodiments, the X type zeolite has a ratio of SiO₂/Al₂O₃ of 2.3 to 2.5, or a particle size in a range of 1.7 to 3 microns, or both.

The metal oxide component comprises a metal oxide, or a mixed metal oxide, or combinations thereof. The metal oxide component is present in an amount in a range of 15 to 45 wt % of the adsorbent composition, or 15 to 40 wt %, or 15 to 35 wt %, or 15 to 30 wt %, or 20 to 45 wt %, or 20 to 40 wt %, or 25 to 35 wt %, or 25 to 45 wt %, or 25 to 40 wt %, or 25 to 35 wt %, or 25 to 30 wt %.

The metal carbonate component comprises a metal carbonate. The metal carbonate component is present in an amount in a range of 10 to 45 wt % of the adsorbent composition, or 10 to 40 wt %, or 10 to 35 wt %, or 15 to 45 wt %., or 15 to 40 wt %., or 15 to 35 wt %, or 20 to 45 wt %., or 20 to 40 wt %., or 20 to 35 wt %, or 25 to 45 wt %., or 25 to 40 wt %., or 25 to 35 wt %.

The ratio of metal oxide component to metal carbonate component may be in the range of 1.25:1 to 2.3:1, or 1.25:1 to 2:1, or 1.25:1 to 1.7:1, or 1.7:1 to 2.3:1, or 1.7:1 to 2:1, or 2:1 to 2.3:1.

The metal in the metal oxide component or the metal in the metal carbonate component, or both may comprise a metal from Groups 1 or 7-12 of the Periodic Table, or combinations thereof. In some embodiments, the metal in the metal oxide component, or the metal in the metal carbonate component, or both comprises sodium, potassium, lithium, zinc, nickel, iron, manganese, or combinations thereof.

In some embodiments, the metal in the metal oxide component, or the metal in the metal carbonate component, or both comprises a metal from Group 1 of the Periodic Table, and the total amount of the metal from Group 1 of the periodic Table in the adsorbent composition is in a range of 5 to 10 wt % of the absorbent composition; or the metal in the metal oxide component, or the metal in the metal carbonate component, or both comprises a metal from Groups 7-12 of the Periodic Table, and the total amount of the metal from Groups 7-12 of the periodic Table in the adsorbent composition is in a range of 15 to 25 wt % of the absorbent composition; or both.

The adsorbent composition is free of an alumina component and has a saturation capacity for inorganic chloride of 25 wt % or more, or 30 wt % or more, or 40 wt % or more, or 50 wt % or more, or 60 wt % or more, or 70 wt % or more. The saturation capacity is based on gravimetric capacity, which is measured using ASTM UOP 291.

In some embodiments, the saturation capacity for inorganic chloride is at least twice the saturation capacity for inorganic chloride of a zeolite adsorbent alone, or at least twice the saturation capacity for inorganic chloride of a activated alumina adsorbent alone, or greater than the saturation capacity for inorganic chloride of a mixed metal oxide catalyst alone, or combinations thereof.

In some embodiments, the saturation capacity for inorganic chloride is at least 2.2 times the saturation capacity for inorganic chloride of a zeolite adsorbent alone, or at least 2.2 times the saturation capacity for inorganic chloride of a activated alumina adsorbent alone, or both. In some embodiments, the saturation capacity for inorganic chloride is at least 2.5 times the saturation capacity for inorganic chloride of a zeolite adsorbent alone, or at least 2.5 times the saturation capacity for inorganic chloride of a activated alumina adsorbent alone, or both. In some embodiments, the saturation capacity for inorganic chloride is at least 2.7 times the saturation capacity for inorganic chloride of a zeolite adsorbent alone, or at least 3 times the saturation capacity for inorganic chloride of a zeolite adsorbent alone. In some embodiments, the saturation capacity for inorganic chloride is at least 2.7 times the saturation capacity for inorganic chloride of a activated alumina adsorbent alone, or at least 3 times the saturation capacity for inorganic chloride of a activated alumina adsorbent alone.

The adsorbent composition may further comprise 5 to 30 wt % of a binder component, or 5 to 25 wt %, or 5 to 20 wt %, or 5 to 15 wt %, or 5 to 10 wt %. The binder component may be a clay. Any suitable clay may be used, including but not limited to, attapulgite and kaolin.

In some embodiments, the adsorbent composition may have a bulk density of 43 lbs/ft³ or more.

In some embodiments, the adsorbent composition may have a crush strength of 5.6 lbs or more. In some embodiments, the crush strength is in the range of 5.6 lbs, to 25 lbs, or 8 lbs, to 25 lbs, or 10 lbs, to 25 lbs, or 5.6 lbs, to 20 lbs, or 8 lbs, to 20 lbs, or 10 lbs, to 20 lbs, or 5.6 lbs, to 17 lbs, or 8 lbs, to 17 lbs, or 10 lbs, to 17 lbs, or 5.6 lbs, to 14 lbs, or 8 lbs, to 14 lbs, or 10 lbs, to 14 lbs.

In some embodiments, the adsorbent composition may have a BET surface area in the range of about 40 to 160 m²/g.

In some embodiments, the adsorbent composition comprises: 30 to 60 wt % of a zeolite component consisting essentially of an X type zeolite; 15 to 35 wt % of a metal oxide component comprising a metal oxide, or a mixed metal oxide, or combinations thereof; 10 to 35 wt % of a metal carbonate component comprising a metal carbonate; and optionally 5 to 20 wt % of binder component; wherein the adsorbent composition is free of an alumina component and has a saturation capacity for chloride of 25% or more; and wherein the adsorbent composition has a bulk density of 43 lbs/ft³ or more, a crush strength of 5.6 lbs or more, or both.

The organic chloride capacity is at least the same as a commercial zeolite, despite having a much lower zeolite content. For example, an adsorbent composition having a zeolite content in the range of 30-60 wt % had a greater organic chloride capacity than a commercial zeolite product having a zeolite content of 60-90%.

The adsorbent composition showed good hydrothermal stability and mechanical strength. In Addition, there was no oligomerization or polymerization of the adsorbent composition due to adsorbent reactivity.

The adsorbent composition may be made by any suitable process known in the art. Suitable processes include, but are not limited to, those described in U.S. Pat. Nos. 7,758,837 and 10,737,237 each of which is incorporated herein by reference.

Another aspect of the invention is a method of removing organic chlorides and inorganic chlorides from a process fluid. In one embodiment, the process comprises: contacting the process fluid with an adsorbent composition comprising: a zeolite component consisting essentially of an X type zeolite; a metal oxide component comprising a metal oxide, or a mixed metal oxide, or combinations thereof; a metal carbonate component comprising a metal carbonate; and optionally a binder component; wherein the adsorbent composition is free of an alumina component and has a saturation capacity for inorganic chloride of 25% or more.

The process fluid can be a gas or a liquid.

In some embodiments, the zeolite component is present in an amount in a range of 30 to 60 wt % of the adsorbent composition; or the metal oxide component is present in an amount in a range of 15 to 35 wt % of the adsorbent composition; or the metal carbonate component is present in an amount in a range of 10 to 35 wt % of the adsorbent composition; or combinations thereof.

In some embodiments, the ratio of the metal oxide component to the metal carbonate component is in a range of 2.3:1 to 1.25:1.

In some embodiments, the zeolite has a ratio of SiO₂/Al₂O₃ of 2.0 to 2.5, or a particle size in a range of 1.5 to 6 microns, or both.

In some embodiments, the metal in the metal oxide component, or the metal in the metal carbonate component comprises a metal from Groups 1 or 7-12 of the Periodic Table, or combinations thereof.

### EXAMPLES

### Adsorbent Composition Preparation

13.4 g of 13X type zeolite, 5.13 g of zinc oxide, 3.02 g of sodium carbonate, and 3.74 g of binder were mixed together well. 8.1 g of water was added to make a homogeneous dough. The dough was processed to make a cylindrical extrudate which was dried to maintain the optimal LOI. The dried material was kept in an oven for calcination at a temperature of 300-450° C. for 2 hr.

### Experiment 1

The performance of selected samples to scavenge HCl was determined with about 15 cubic centimeters sample in a flow reactor at a gas hourly space velocity of about 478 hr⁻¹ and 22° to 23° C. temperature. A gas blend of about 1% HCl in nitrogen was used, and the breakthrough of HCl out the bed was indicated by the pH change of calibrated NaOH solutions. The outlet gas from the reactor was passed through the aqueous solution of NaOH until the pH reached about 2 (until saturation of the adsorbent bed). After reaching the pH of about 2, the HCl gas flow was stopped, and the saturated adsorbent bed was purged with N₂ for 2 h before unloading the adsorbent. After the HCl breakthrough was detected, a brief purge with nitrogen was followed by unloading the adsorbent bed. The chloride content of the spent sample A was analyzed, as well as the typical molecular sieve (1) and typical activated alumina (2). The inorganic chloride capacity for the typical mixed metal oxide (3) adsorbents are based on publicly available third party results.

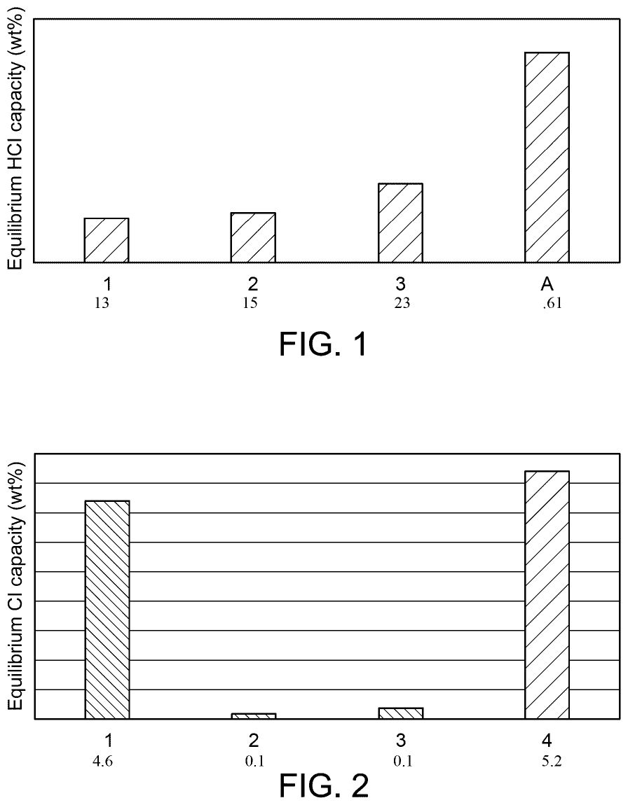

The results are shown in FIG. 1. As can be seen, the inorganic chloride capacity of Sample A is well over twice that of the typical mixed metal oxide adsorbent (which has a higher inorganic chloride capacity than either the typical molecular sieve or the typical activated alumina adsorbents).

### Experiment 2

The organic chloride uptake capacity of the formed materials was evaluated. The sample A adsorbent was added to a simulated feed containing 2-chlorobutane in heptane and held overnight while shaking the contents. The spent sample A adsorbent was analyzed for % chloride analysis. The organic chloride capacity of typical molecular sieve (1), typical activated alumina (2), and typical mixed metal oxide (3) adsorbents was also tested using the same procedure and compared with sample A

As Shown in FIG. 2. the typical molecular sieve (1), which contains about 60 to 90 wt % of the same X type zeolite, showed good organic chloride capacity, and it is among the best commercial adsorbents for organic chloride. The organic chloride uptake capacity of sample A is better than the commercial adsorbent despite having about half the amount of zeolite\.

### Experiment 3

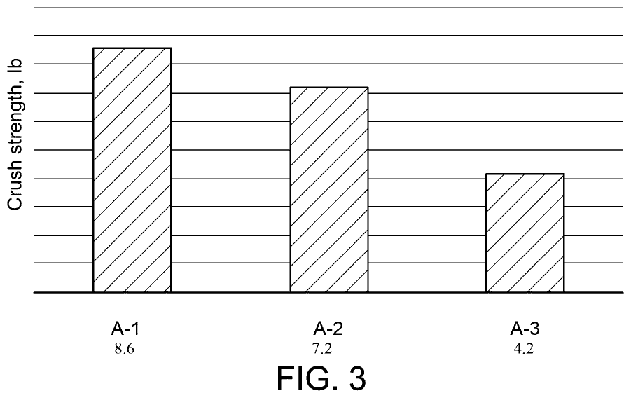

The hydrothermal stability of the spent sample was determined using a lab steam generator set up. Steam was continuously passed over the spent sample for 6 hours. After 6 hours, the sample was removed from the steam and air dried. The dried material was submitted for the crush strength testing according to ASTM UOP 914. The crush strength of fresh sample A (A-1), spent sample A (i.e., after treatment with HCl as described in Experiment 2) (A-2), and steamed spent sample A (A-3) were compared. The results are shown in FIG. 3.

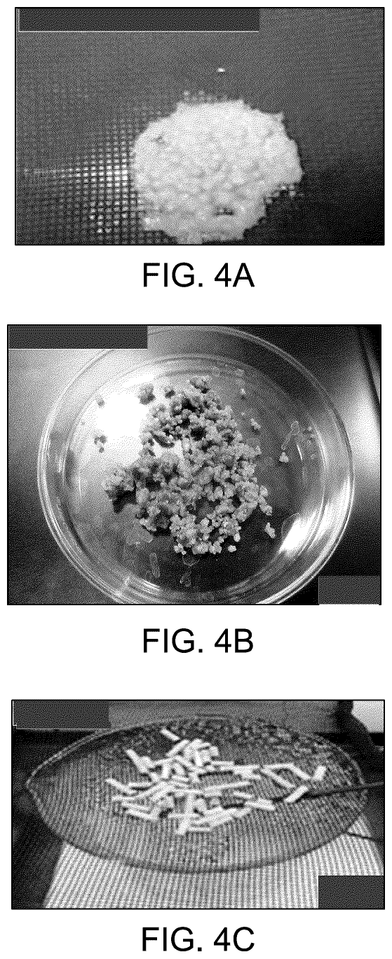

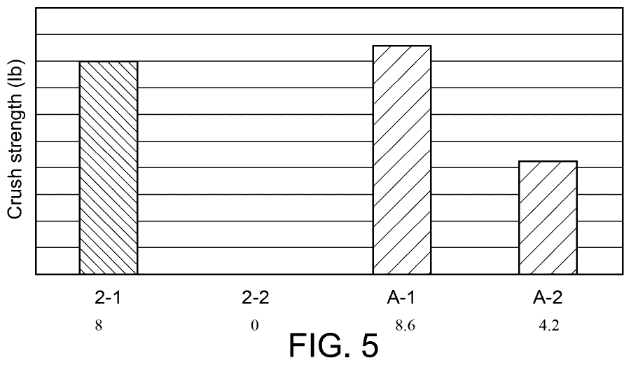

The crush strength of sample A was compared with commercial adsorbents in FIGS. 4A-4C and 5. The typical activated alumina (FIG. 4A) completely disintegrated during steaming, and the typical mixed metal oxide (FIG. 4B) disintegrated during HCl treatment. The spent sample A adsorbent showed good hydrothermal stability; it was intact after HCl treatment followed by 6 h steaming (FIG. 4C).

The mechanical strength of typical activated alumina and sample A was analyzed fresh (2-1, A-1) and after 6 hours of steaming treatment (2-2, A-2). The typical activated alumina (2-2) completely disintegrated after steaming and therefore had no crush strength. Sample A showed good mechanical properties fresh and steamed, with the steamed sample A having a crush strength above 4 lbf. Sample A showed good steam and breakup stability, even though the zeolite content is relatively small compared to the typical zeolite product (45 wt % v 60-90 wt %).

### Experiment 4

The reactivity or green oil formation of the adsorbent was tested using an isobutylene reactivity test. Liquid isobutylene was slowly heated in an autoclave in presence of the adsorbent. Both the autoclave pressure and temperature were monitored over the test period and compared with a blank experiment where no adsorbent was used. The autoclave was heated up to 70° C. and held at that temperature for an extended time.

Sample A showed no reactivity. There was no decrease in pressure in the autoclave, which indicates that there was no oligomerization or polymerization due to adsorbent reactivity, and no green oil formation.

### SPECIFIC EMBODIMENTS

While the following is described in conjunction with specific embodiments, it will be understood that this description is intended to illustrate and not limit the scope of the preceding description and the appended claims.

A first embodiment of the invention is an adsorption composition for organic and inorganic chloride removal comprising a zeolite component consisting essentially of an X type zeolite; a metal oxide component comprising a metal oxide, or a mixed metal oxide, or combinations thereof; and a metal carbonate component comprising a metal carbonate; wherein the adsorbent composition is free of an alumina component and has a saturation capacity for inorganic chloride of 25% or more. An embodiment of the invention is one, any or all of prior embodiments in this paragraph up through the first embodiment in this paragraph wherein the zeolite component is present in an amount in a range of 30 to 60 wt % of the adsorbent composition. An embodiment of the invention is one, any or all of prior embodiments in this paragraph up through the first embodiment in this paragraph wherein the metal oxide component is present in an amount in a range of 15 to 35 wt % of the adsorbent composition. An embodiment of the invention is one, any or all of prior embodiments in this paragraph up through the first embodiment in this paragraph wherein the metal carbonate component is present in an amount in a range of 10 to 35 wt % of the adsorbent composition. An embodiment of the invention is one, any or all of prior embodiments in this paragraph up through the first embodiment in this paragraph wherein a ratio of the metal oxide component to the metal carbonate component is in a range of 2.31 to 1.251. An embodiment of the invention is one, any or all of prior embodiments in this paragraph up through the first embodiment in this paragraph wherein the X type zeolite has a ratio of SiO₂/Al₂O₃ of 2.0 to 2.5, or a particle size in a range of 1.5 to 6 microns, or both. An embodiment of the invention is one, any or all of prior embodiments in this paragraph up through the first embodiment in this paragraph wherein the X type zeolite has a ratio of SiO₂/Al₂O₃ of 2.3 to 2.5, or a particle size in a range of 1.7 to 3 microns, or both. An embodiment of the invention is one, any or all of prior embodiments in this paragraph up through the first embodiment in this paragraph wherein a metal in the metal oxide component or a metal in the metal carbonate component, or both comprises a metal from Groups 1 or 7-12 of the Periodic Table, or combinations thereof. An embodiment of the invention is one, any or all of prior embodiments in this paragraph up through the first embodiment in this paragraph wherein a metal in the metal oxide component, or a metal in the metal carbonate component comprises sodium, potassium, lithium, zinc, nickel, iron, manganese, or combinations thereof. An embodiment of the invention is one, any or all of prior embodiments in this paragraph up through the first embodiment in this paragraph wherein a metal in the metal oxide component, or a metal in the metal carbonate component, or both comprises a metal from Group 1 of the Periodic Table, and a total amount of the metal from Group 1 of the periodic Table in the adsorbent composition is in a range of 5 to 10 wt % of the absorbent composition; or a metal in the metal oxide component, or a metal in the metal carbonate component, or both comprises a metal from Groups 7-12 of the Periodic Table, and a total amount of the metal from Groups 7-12 of the periodic Table in the adsorbent composition is in a range of 15 to 25 wt % of the absorbent composition; or both. An embodiment of the invention is one, any or all of prior embodiments in this paragraph up through the first embodiment in this paragraph further comprising 5 to 20 wt % of a binder component. An embodiment of the invention is one, any or all of prior embodiments in this paragraph up through the first embodiment in this paragraph wherein the saturation capacity for inorganic chloride is at least twice the saturation capacity for inorganic chloride of a zeolite adsorbent alone, or at least twice the saturation capacity for inorganic chloride of a activated alumina adsorbent alone, or greater than the saturation capacity for inorganic chloride of a mixed metal oxide catalyst alone, or combinations thereof. An embodiment of the invention is one, any or all of prior embodiments in this paragraph up through the first embodiment in this paragraph wherein the saturation capacity for chloride is at least 2.5 times the saturation capacity for inorganic chloride of a zeolite adsorbent alone, or at least 2.5 times the saturation capacity for inorganic chloride of a activated alumina adsorbent alone, or both. An embodiment of the invention is one, any or all of prior embodiments in this paragraph up through the first embodiment in this paragraph wherein the adsorbent composition has a bulk density of 43 lbs/ft³ or more, or a crush strength of 5.6 lbs or more, or a BET surface area in a range of about 40 to 160 m²/g, or combinations thereof.

A second embodiment of the invention is a composition for organic and inorganic chloride removal comprising 30 to 60 wt % of a zeolite component consisting essentially of an X type zeolite; 15 to 35 wt % of a metal oxide component comprising a metal oxide, or a mixed metal oxide, or combinations thereof; 10 to 35 wt % of a metal carbonate component comprising a metal carbonate; and optionally 5 to 20 wt % of binder component. wherein the adsorbent composition is free of an alumina component and has a saturation capacity for inorganic chloride of 25% or more; and wherein the adsorbent composition has a bulk density of 43 lbs/ft³ or more, a crush strength of 5.6 lbs or more, or both.

A third embodiment of the invention is a method of removing organic chlorides and inorganic chlorides from a process fluid comprising contacting the process fluid with an adsorbent composition comprising a zeolite component consisting essentially of an X type zeolite; a metal oxide component comprising a metal oxide, or a mixed metal oxide, or combinations thereof; metal carbonate component comprising a metal carbonate; and optionally a binder component; wherein the adsorbent composition is free of an alumina component and has a saturation capacity for inorganic chloride of 25% or more. An embodiment of the invention is one, any or all of prior embodiments in this paragraph up through the third embodiment in this paragraph wherein the zeolite component is present in an amount in a range of 30 to 60 wt % of the adsorbent composition; or wherein the metal oxide component is present in an amount in a range of 15 to 35 wt % of the adsorbent composition; or wherein the metal carbonate component is present in an amount in a range of 10 to 35 wt % of the adsorbent composition; or combinations thereof. An embodiment of the invention is one, any or all of prior embodiments in this paragraph up through the third embodiment in this paragraph wherein a ratio of the metal oxide component to the metal carbonate component is in a range of 2.31 to 1.251. An embodiment of the invention is one, any or all of prior embodiments in this paragraph up through the third embodiment in this paragraph wherein the zeolite has a ratio of SiO₂/Al₂O₃ of 2.0 to 2.5, or a particle size in a range of 1.5 to 6 microns, or both. An embodiment of the invention is one, any or all of prior embodiments in this paragraph up through the third embodiment in this paragraph wherein a metal in the metal oxide component, or a metal in the metal carbonate component comprises a metal from Groups 1 or 7-12 of the Periodic Table, or combinations thereof.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. An adsorbent composition for organic and inorganic chloride removal comprising:
a zeolite component consisting essentially of an X type zeolite;
a metal oxide component comprising a metal oxide, or a mixed metal oxide, or combinations thereof; and
a metal carbonate component comprising a metal carbonate;
wherein the adsorbent composition is free of an alumina component and has a saturation capacity for inorganic chloride of 25% or more.

2. The adsorbent composition of claim 1 wherein the zeolite component is present in an amount in a range of 30 to 60 wt % of the adsorbent composition.

3. The adsorbent composition of claim 1 wherein the metal oxide component is present in an amount in a range of 15 to 35 wt % of the adsorbent composition.

4. The adsorbent composition of claim 1 wherein the metal carbonate component is present in an amount in a range of 10 to 35 wt % of the adsorbent composition.

5. The adsorbent composition of claim 1 wherein a ratio of the metal oxide component to the metal carbonate component is in a range of 2.3:1 to 1.25:1.

6. The adsorbent composition of claim 1 wherein the X type zeolite has a ratio of SiO₂/Al₂O₃ of 2.0 to 2.5, or a particle size in a range of 1.5 to 6 microns, or both.

7. The adsorbent composition of claim 1 wherein the X type zeolite has a ratio of SiO₂/Al₂O₃ of 2.3 to 2.5, or a particle size in a range of 1.7 to 3 microns, or both.

8. The adsorbent composition of claim 1 wherein a metal in the metal oxide component or a metal in the metal carbonate component, or both comprises a metal from Groups 1 or 7-12 of the Periodic Table, or combinations thereof.

9. The adsorbent composition of claim 1 wherein a metal in the metal oxide component, or a metal in the metal carbonate component comprises sodium, potassium, lithium, zinc, nickel, iron, manganese, or combinations thereof.

10. The adsorbent composition of claim 1 wherein:
a metal in the metal oxide component, or a metal in the metal carbonate component, or both comprises a metal from Group 1 of the Periodic Table, and a total amount of the metal from Group 1 of the periodic Table in the adsorbent composition is in a range of 5 to 10 wt % of the absorbent composition; or
a metal in the metal oxide component, or a metal in the metal carbonate component, or both comprises a metal from Groups 7-12 of the Periodic Table, and a total amount of the metal from Groups 7-12 of the periodic Table in the adsorbent composition is in a range of 15 to 25 wt % of the absorbent composition; or
both.

11. The adsorbent composition of claim 1 further comprising 5 to 20 wt % of a binder component.

12. The adsorbent composition of claim 1 wherein the saturation capacity for inorganic chloride is at least twice the saturation capacity for inorganic chloride of a zeolite adsorbent alone, or at least twice the saturation capacity for inorganic chloride of a activated alumina adsorbent alone, or greater than the saturation capacity for inorganic chloride of a mixed metal oxide catalyst alone, or combinations thereof.

13. The adsorbent composition of claim 1 wherein the saturation capacity for inorganic chloride is at least 2.5 times the saturation capacity for inorganic chloride of a zeolite adsorbent alone, or at least 2.5 times the saturation capacity for inorganic chloride of a activated alumina adsorbent alone, or both.

14. The adsorbent composition of claim 1 wherein the adsorbent composition has a bulk density of 43 lbs/ft³ or more, or a crush strength of 5.6 lbs or more, or a BET surface area in a range of about 40 to 160 m²/g, or combinations thereof.

15. An adsorbent composition for organic and inorganic chloride removal comprising:
30 to 60 wt % of a zeolite component consisting essentially of an X type zeolite;
15 to 35 wt % of a metal oxide component comprising a metal oxide, or a mixed metal oxide, or combinations thereof;
10 to 35 wt % of a metal carbonate component comprising a metal carbonate; and
optionally 5 to 20 wt % of binder component;
wherein the adsorbent composition is free of an alumina component and has a saturation capacity for inorganic chloride of 25% or more; and
wherein the adsorbent composition has a bulk density of 43 lbs/ft³ or more, a crush strength of 5.6 lbs or more, or both.

16. A method of removing organic chlorides and inorganic chlorides from a process fluid comprising:
contacting the process fluid with an adsorbent composition comprising:
a zeolite component consisting essentially of an X type zeolite;
a metal oxide component comprising a metal oxide, or a mixed metal oxide, or combinations thereof;
a metal carbonate component comprising a metal carbonate; and
optionally a binder component;
wherein the adsorbent composition is free of an alumina component and has a saturation capacity for inorganic chloride of 25% or more.

17. The method of claim 16:
wherein the zeolite component is present in an amount in a range of 30 to 60 wt % of the adsorbent composition; or
wherein the metal oxide component is present in an amount in a range of 15 to 35 wt % of the adsorbent composition; or
wherein the metal carbonate component is present in an amount in a range of 10 to 35 wt % of the adsorbent composition; or
combinations thereof.

18. The method of claim 16 wherein a ratio of the metal oxide component to the metal carbonate component is in a range of 2.3:1 to 1.25:1.

19. The method of claim 16 wherein the zeolite has a ratio of SiO₂/Al₂O₃ of 2.0 to 2.5, or a particle size in a range of 1.5 to 6 microns, or both.

20. The method of claim 16 wherein a metal in the metal oxide component, or a metal in the metal carbonate component comprises a metal from Groups 1 or 7-12 of the Periodic Table, or combinations thereof.
